(19) United States
(12) Patent Application Publication
(10) Pub. No.: US 2016/0182979 A1
(43) Pub. Date: Jun. 23, 2016

(54) METHOD AND SYSTEM FOR PROCESSING CLOSED-CAPTION INFORMATION

(71) Applicants: SONY CORPORATION, Tokyo (JP); SONY NETWORK ENTERTAINMENT INTERNATIONAL LLC, Los Angeles, CA (US)

(72) Inventors: CHARLES McCOY, CORONADO, CA (US); TRUE XIONG, SAN DIEGO, CA (US); VIRAL MEHTA, SAN DIEGO, CA (US); KEVIN ZHANG, SAN DIEGO, CA (US)

(21) Appl. No.: 14/578,905

(22) Filed: Dec. 22, 2014

(51) Int. Cl. H04N 21/854; H04N 21/488; H04N 21/643; H04N 21/2183; H04N 21/435; H04N 21/4782; H04N 21/475

(52) U.S. Cl. CPC H04N 21/85406; H04N 21/4782; H04N 21/4888; H04N 21/4753; H04N 21/2183; H04N 21/4884; H04N 21/4355; H04N 21/64322

(57) ABSTRACT

Various aspects of a method and system to process closed-caption information are disclosed herein. In an embodiment, in response to the receipt of a first request from an electronic device, the method includes retrieval of metadata associated with media content displayed at the electronic device. The retrieved metadata may be dynamically converted from the first format to a second format based on the first request.

### FIELD

Various embodiments of the disclosure relate to processing of closed-caption information. More specifically, various embodiments of the disclosure relate to processing of closed-caption information associated with Internet Protocol Television (IPTV) content.

### BACKGROUND

In recent years, with the increase in the popularity of Internet Protocol Television (IPTV), many IPTV content providers have also emerged in the market. It has become desirable and, in some regions of the world, mandatory to have closed-caption information for IPTV content. Currently, closed-caption information from different content sources may be provided in different formats.

In certain scenarios, various electronic devices that display IPTV content may only support a subset of available formats. Further, a user may want to view closed-caption information for a live IPTV program displayed at an electronic device. However, the file that includes complete closed-caption information related to the live IPTV program may be missing from the incoming IPTV content stream. In such an instance, the electronic device may not display closed-caption information in a supported format.

Further limitations and disadvantages of conventional and traditional approaches will become apparent to one of skill in the art, through comparison of described systems with some aspects of the present disclosure, as set forth in the remainder of the present application and with reference to the drawings.

### SUMMARY

A method and a system to process closed-caption information substantially as shown in, and/or described in connection with, at least one of the figures, as set forth more completely in the claims.

These and other features and advantages of the present disclosure may be appreciated from a review of the following detailed description of the present disclosure, along with the accompanying figures in which like reference numerals refer to like parts throughout.

### BRIEF DESCRIPTION OF THE DRAWINGS

FIG. 1 is a block diagram that illustrates a network environment that processes closed-caption information, in accordance with an embodiment of the disclosure.

FIG. 2 is a block diagram that illustrates an exemplary conversion module, in accordance with an embodiment of the disclosure.

FIG. 3 is a block diagram that illustrates an exemplary electronic device, in accordance with an embodiment of the disclosure.

FIG. 4 illustrates an exemplary scenario for the disclosed implementation of the method and system that processes closed-caption information, in accordance with an embodiment of the disclosure.

FIGS. 5A and 5B are a flow chart that illustrates an exemplary method to process closed-caption information, in accordance with an embodiment of the disclosure.

### DETAILED DESCRIPTION

The following described implementations may be found in disclosed methods and systems that process closed-caption information. Exemplary aspects of the disclosure may comprise a method that may retrieve metadata associated with media content. The media content may be displayed at an electronic device. Such retrieval may occur in response to a first request received from the electronic device. The retrieved metadata may be dynamically converted from the first format to a second format. In an embodiment, the metadata may be closed-captioning information or subtitle information. The displayed media content may correspond to pre-recorded or live internet protocol television (IPTV) content. The retrieved metadata may be in a first format not supported by the electronic device. The second format is supported by the electronic device.

In an embodiment, the method may comprise receipt of the first request from the electronic device. The first request may comprise an authentication data, a first identifier for the metadata associated with the media content, and a second identifier for the media content.

In an embodiment, the method may comprise determination of whether the electronic device is authorized to receive the metadata from a conversion module. The determination of authorization may be based on a comparison of the indicated authentication data with a pre-stored authentication data.

In an embodiment, the metadata may be retrieved in one or more segments based on one or more discrete requests communicated from the conversion module to a content server. In an embodiment, the method may comprise detection of errors in the metadata retrieved from the content server based on a checksum parameter associated with the metadata.

In an embodiment, the method may comprise determination of a first duration associated with the retrieval and the conversion of the closed-captioning information. In an embodiment, the method may comprise communication of a notification associated with the conversion of the metadata to the electronic device. Such communication may be based on the determined first duration.

In an embodiment, the method may comprise determination of a second duration associated with occurrence of the converted metadata in the media content. Such determination may occur based on frame rate information associated with the media content, and/or location information of the retrieved metadata in the media content.

In an embodiment, the method may comprise an update of a first sub-metadata associated with the converted metadata, based on the determined second duration. The updated first sub-metadata may be utilized when the metadata synchronizes with the media content displayed at the electronic device.

In an embodiment, the method may comprise conversion of a first character encoding scheme associated with the retrieved metadata to a second character encoding scheme. Such conversion may be based on the first request.

In an embodiment, the method may comprise caching of the converted metadata. In an embodiment, the method may comprise utilization of the cached metadata when a second request for same metadata may be received from the electronic device. In an embodiment, the method may comprise utilization of the cached metadata when another request for same metadata is received from another electronic device.

In an embodiment, the method may comprise comparison of the cached metadata with the metadata stored at the content server. Such comparison may be based on a date parameter, a time parameter, a file size parameter, and/or a checksum. In an embodiment, the method may comprise detection of a modification in the metadata stored at the content server based on the comparison.

In an embodiment, the method may comprise communication of a second sub-metadata to the electronic device. The second sub-metadata may comprise a location identifier for the converted metadata. The second sub-metadata may be utilized by the electronic device to retrieve the converted metadata. In an embodiment, the location identifier may be a uniform resource locator (URL).

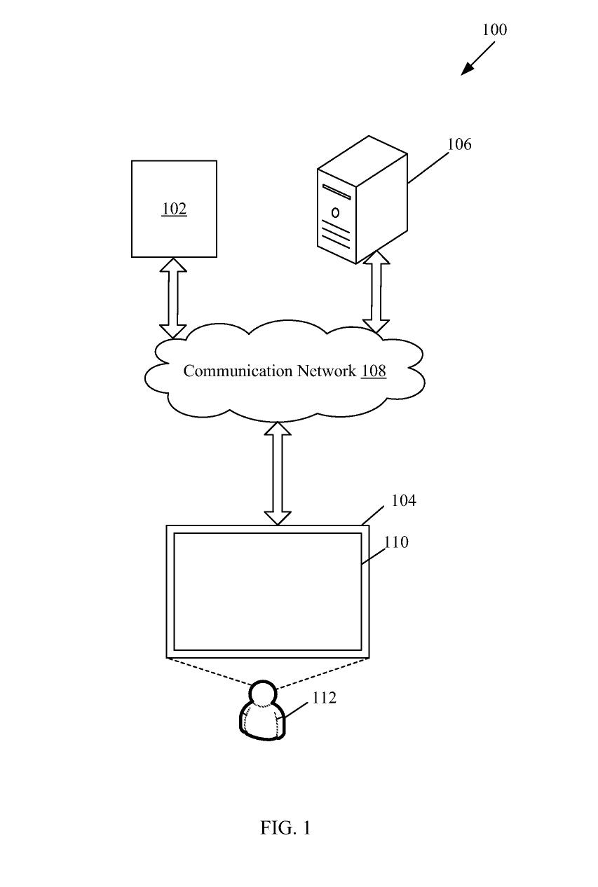

FIG. 1 is a block diagram that illustrates a network environment 100 that processes closed-caption information, in accordance with an embodiment of the disclosure. With reference to FIG. 1, there is shown a conversion module 102, an electronic device 104, a content server 106, a communication network 108, a display screen 110, and one or more users, such as a user 112.

The conversion module 102 may be communicatively coupled with the electronic device 104 and the content server 106, via the communication network 108. The electronic device 104 may include the display screen 110. The electronic device 104 may be associated with the user 112.

The conversion module 102 may comprise suitable logic, circuitry, interfaces, and/or code that may be operable to receive requests from one or more subscribed devices, such as the electronic device 104. The conversion module 102 may be operable to convert metadata that may be retrieved from the content server 106 from a first format to a second format. The metadata may be closed-captioning information and/or subtitle information associated with media content. The conversion module 102 may be implemented using several technologies that are well known to those skilled in the art.

The electronic device 104 may comprise suitable logic, circuitry, interfaces, and/or code that may be operable to display media content received from the content server 106. The media content may correspond to pre-recorded or live IPTV content. Examples of the electronic device 104 may include, but are not limited to, a smartphone, a tablet computer, a laptop, an Internet Protocol Television (IPTV), a Personal Digital Assistant (PDA) device, a cable box, a satellite box, a personal computer (PC), a network video box, a digital video disc (DVD) player, and/or a Blu-ray player.

The content server 106 may comprise suitable logic, circuitry, interfaces, and/or code that may be operable to store media content and associated metadata. The media content may correspond to pre-recorded or live IPTV content. In an embodiment, the content server 106 may be operable to receive live IPTV content and broadcast the received live IPTV content to one or more electronic devices, such as the electronic device 104. In an embodiment, the content server 106 may be of a network operator (not shown). The content server 106 may be implemented using several technologies that are well known to those skilled in the art.

The communication network 108 may include a medium through which the conversion module 102 may communicate with one or more servers, such as the content server 106, and one or more electronic devices, such as the electronic device 104. Examples of the communication network 108 may include, but are not limited to, the Internet, a cloud network, a Wireless Fidelity (Wi-Fi) network, a Wireless Local Area Network (WLAN), a Local Area Network (LAN), a telephone line (POTS), and/or a Metropolitan Area Network (MAN). Various devices in the network environment 100 may be operable to connect to the communication network 108, in accordance with various wired and wireless communication protocols. Examples of such wired and wireless communication protocols may include, but are not limited to, Transmission Control Protocol and Internet Protocol (TCP/IP), User Datagram Protocol (UDP), Hypertext Transfer Protocol (HTTP), File Transfer Protocol (FTP), ZigBee, EDGE, infrared (IR), IEEE 802.11, 802.16, cellular communication protocols, and/or Bluetooth (BT) communication protocols.

The display screen 110 may comprise suitable logic, circuitry, interfaces, and/or code that may be operable to display the converted metadata and associated media content, via a media player. The media player may be operable to display prerecorded or live IPTV content. The display screen 110 may be further operable to render one or more features and/or applications of the electronic device 104. The display screen 110 may be realized through several known technologies such as but not limited to, Liquid Crystal Display (LCD) display, Light Emitting Diode (LED) display, and/or Organic LED (OLED) display technology.

In operation, the electronic device 104 may be operable to communicate a first request to the conversion module 102. In an embodiment, the first request may be indicative of an input that may be provided by the user 112. In an embodiment, the first request may be based on a preconfigured setting related to display of the metadata on the display screen 110 of the electronic device 104.

In an embodiment, the conversion module 102 may be operable to receive the first request from the electronic device 104. In an embodiment, the first request may comprise authentication data, a first identifier for the metadata associated with the displayed media content, and a second identifier for the displayed media content.

In an embodiment, the conversion module 102 may be operable to determine whether the electronic device 104 may be authorized to receive the metadata from the conversion module 102. Such a determination may be based on a comparison of the received authentication data with a pre-stored authentication data.

In an embodiment, the conversion module 102 may be operable to communicate one or more discrete requests to the content server 106. In an embodiment, the communication of one or more discrete requests may be based on the determination related to the authentication of the electronic device 104.

In an embodiment, the conversion module 102 may be operable to retrieve metadata associated with the media content displayed at the electronic device 104. The metadata may be retrieved from the content server 106. Such retrieval may occur in response to the first request received from the electronic device 104. The retrieved metadata may be in the first format not supported by the electronic device 104.

In an embodiment, the conversion module 102 may be operable to dynamically convert the retrieved metadata from the first format to a second format. Such conversion may be based on the first request. The second format may be supported by the electronic device 104.

In an embodiment, the conversion module 102 may be operable to determine a first duration associated with the retrieval and conversion of the metadata. In an embodiment, the first duration may refer to total time required for the retrieval and the conversion.

In an embodiment, the conversion module 102 may be operable to determine a second duration associated with occurrence of the converted metadata in the media content. Such determination of the second duration may be based on frame rate information associated with the media content. Such determination of the second duration may be further based on location information of the retrieved metadata in the media content.

In an embodiment, the conversion module 102 may be operable to update a first sub-metadata associated with the converted metadata, based on the determined second duration. The updated first sub-metadata may be utilized when the metadata is synchronized with the media content displayed at the electronic device 104.

In an embodiment, the conversion module 102 may be operable to convert a first character encoding scheme associated with the retrieved metadata to a second character encoding scheme. Such conversion may be based on the first request. The first request may indicate use of the second character encoding scheme at the electronic device 104. In an embodiment, the conversion module 102 may be operable to convert text of the retrieved metadata from a first language to a second language.

In an embodiment, the conversion module 102 may be operable to cache the converted metadata. In an embodiment, the cached metadata may be utilized when a second request for the metadata is received from the electronic device 104 or another electronic device.

In an embodiment, the conversion module 102 may be operable to communicate a second sub-metadata to the electronic device 104. The second sub-metadata may comprise a location identifier, such as a URL, for the converted metadata.

In an embodiment, the electronic device 104 may be operable to receive and display the converted metadata from the conversion module 102. Such receipt may occur by use of the second sub-metadata that may be received from the conversion module 102. Such receipt may be in response to the first request communicated to the conversion module 102. The display may occur on the display screen 110, via a media player, such as a browser. In an embodiment, the functionalities of the conversion module 102 may be implemented in other devices, such as the electronic device 104 and/or the content server 106, without deviating from the scope of the disclosure.

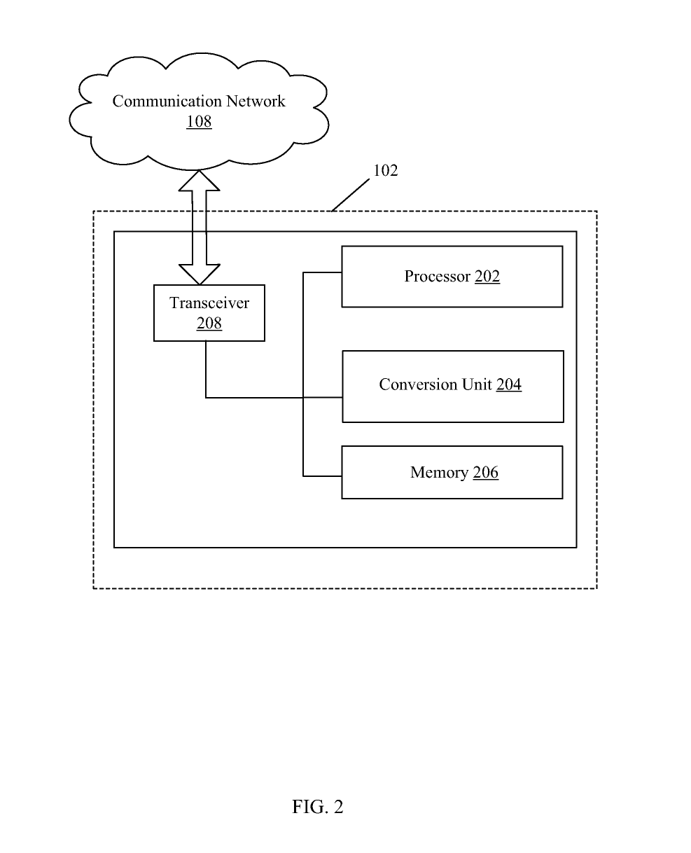

FIG. 2 is a block diagram that illustrates an exemplary conversion module, in accordance with an embodiment of the disclosure. FIG. 2 is explained in conjunction with elements from FIG. 1. With reference to FIG. 2, there is shown the conversion module 102. The conversion module 102 may comprise one or more processors, such as a processor 202, a conversion unit 204, a memory 206, and a transceiver 208. The processor 202 may be connected to the conversion unit 204, the memory 206, and the transceiver 208. The transceiver 208 may be operable to communicate with one or more electronic devices, such as the electronic device 104, and other servers, such as the content server 106, via the communication network 108.

The processor 202 may comprise suitable logic, circuitry, interfaces, and/or code that may be operable to execute a set of instructions stored in the memory 206. The processor 202 may be implemented, based on a number of processor technologies known in the art. Examples of the processor 202 may be an X86-based processor, a Reduced Instruction Set Computing (RISC) processor, an Application-Specific Integrated Circuit (ASIC) processor, a Complex Instruction Set Computing (CISC) processor, and/or other processors.

The conversion unit 204 may comprise suitable logic, circuitry, interfaces, and/or code that may be operable to convert the retrieved metadata from the first format to a second format. In an embodiment, the conversion unit 204 may be operable to convert the retrieved metadata from the first format to multiple other formats. Examples of the conversion unit 204 may be an X86-based processor, a Reduced Instruction Set Computing (RISC) processor, an Application-Specific Integrated Circuit (ASIC) processor, a Complex Instruction Set Computing (CISC) processor, and/or other processors. In an embodiment, the conversion unit 204 may be a part of the processor 202. In an embodiment, both the conversion unit 204 and the processor 202 may be implemented as a cluster of processors or an integrated processor that performs the functions of the conversion unit 204 and the processor 202.

The memory 206 may comprise suitable logic, circuitry, and/or interfaces that may be operable to store a machine code and/or a computer program with at least one code section executable by the processor 202. In an embodiment, the memory 206 may be operable to pre-store authentication data. The memory 206 may be further operable to store cache of the converted metadata. Examples of implementation of the memory 206 may include, but are not limited to, Random Access Memory (RAM), Read Only Memory (ROM), Hard Disk Drive (HDD), and/or a Secure Digital (SD) card.

The transceiver 208 may comprise suitable logic, circuitry, interfaces, and/or code that may be operable to receive requests from one or more subscribed devices, such as the electronic device 104. The transceiver 208 may be operable to communicate with one or more other servers, such as the content server 106, via the communication network 108. The transceiver 208 may be further operable to communicate metadata to the electronic device 104. The transceiver 208 may implement known technologies to support wired or wireless communication of the conversion module 102 with the communication network 108. The transceiver 208 may include, but is not limited to, an antenna, a radio frequency (RF) transceiver, one or more amplifiers, a tuner, one or more oscillators, a digital signal processor, a coder-decoder (CODEC) chipset, and/or a local buffer. The transceiver 208 may communicate via wireless communication with networks, such as the Internet, an Intranet and/or a wireless network, such as a cellular telephone network, a wireless local area network (LAN) and/or a metropolitan area network (MAN). The wireless communication may use any of a plurality of communication standards, protocols and technologies, such as Global System for Mobile Communications (GSM), Enhanced Data GSM Environment (EDGE), wideband code division multiple access (W-CDMA), code division multiple access (CDMA), time division multiple access (TDMA), Bluetooth, Wireless Fidelity (Wi-Fi) (such as IEEE 802.11a, IEEE 802.11b, IEEE 802.11g and/or IEEE 802.11n), voice over Internet Protocol (VoIP), Wi-MAX, a protocol for email, instant messaging, and/or Short Message Service (SMS).

In operation, the processor 202 may be operable to receive the first request from the electronic device 104, via the transceiver 208. The first request may comprise the authentication data, the first identifier for the metadata, and the second identifier for the displayed media content. In an embodiment, the first request may correspond to a structured file, such as, “m3u8”. In an embodiment, the first request may correspond to one or more URL's. The first identifier for the metadata, such as a first URL, may locate the metadata associated with the media content at one or more content servers, such as the content server 106. The second identifier for the media content, such as a second URL, may locate the media content at one or more content servers, such as the content server 106.

In an embodiment, the processor 202 may be operable to determine whether the electronic device 104 may be authorized to receive the metadata from the conversion unit 204. Such determination may be based on a comparison of the authentication data with a pre-stored authentication data. The authentication data may be generated using URL data, a timestamp, and a salt value associated with the first request. The timestamp may correspond to time of the first request.

In an embodiment, the processor 202 may be operable to communicate one or more discrete requests to the content server 106, via the transceiver 208. In an embodiment, the communication of one or more discrete requests may be based on the determination related to authentication of the electronic device 104. In an embodiment, the one or more discrete requests may be communicated in a periodic manner.

In an embodiment, the processor 202 may be operable to retrieve the metadata associated with the media content displayed at the electronic device 104. Such retrieval may occur, via the transceiver 208, in response to the first request received from the electronic device 104. In an embodiment, the metadata may be retrieved in one or more segments, based on the one or more discrete requests communicated to the content server 106. In an embodiment, the processor 202 may be operable to retrieve the metadata in a file based on a request communicated from the conversion module 102 to the content server 106. In an embodiment, the processor 202 may be operable to retrieve the metadata, based on a series of discrete requests communicated by the transceiver 202 to the content server 106 in a periodic manner. The retrieved metadata may be in the first format not supported by the electronic device 104.

In an embodiment, the processor 202 may be operable to dynamically detect the first format of the retrieved metadata, based on predetermined unique characteristics of various formats. Such dynamic detection may occur by use of regular expressions known in the art. For example, a SubRip (SRT) format may comprise a numeric digit in the first line followed by a second line. Time codes in SRT may be in hours, minutes, seconds, and/or milliseconds with an arrow sign, “->”, between the time codes of the retrieved closed-caption information. The SRT format may be similar to the web video text tracks (WebVTT) format, except that SRT format may not comprise the phrase, “WEBVTT”, in the first line of the metadata. Different search approaches and/or algorithms, such as greedy algorithms, least greedy to most greedy search approaches, and various other search techniques, may be used to avoid detection of inaccurate results. Notwithstanding, the disclosure may not be so limited and, any suitable search and detection approach may be utilized without limiting the scope of the disclosure.

In an embodiment, the processor 202 may be operable to detect errors in the metadata retrieved from the content server 106. Such detection may be based on a checksum parameter associated with the metadata. When the detected error(s) are within a predetermined threshold, such as error(s) detected in a single caption. Such caption may be left out of the converted metadata. When the detected error(s) exceeds the predetermined threshold, the processor 202 may be operable to generate a log of the detected errors. Such logs may make the service providers aware of the errors in their metadata. Thus, it may facilitate subsequent correction and improvement of quality of the retrieved metadata.

In an embodiment, the conversion unit 204 may be operable to dynamically convert the retrieved metadata from the first format to a second format. Such conversion may be based on the first request. The second format may be supported by the electronic device 104. The first format and the second format may include, but are not limited to, society of motion picture and television engineers (SMPTE) timed text (SMPTE-TT), scenarist closed captioning (SCC), timed text markup language (TTML), distributed format exchange profile (DFXP), WebVTT, SRT, synchronized accessible media interchange (SAMI), European broadcasting union (EBU)-STL, EBU timed text (EBU-TT), and/or Sub Station Alpha (SSA). In an embodiment, the conversion unit 204 may be operable to convert the retrieved metadata from the first format to multiple other formats.

In an embodiment, the processor 202 may be operable to determine the first duration associated with the retrieval and the conversion of the metadata. In an embodiment, the processor 202 may be operable to communicate a notification associated with the conversion of metadata to the electronic device 104 based on the determined first duration.

In an embodiment, the processor 202 may be operable to determine the second duration associated with the occurrence of the converted metadata in the media content. In an embodiment, the determination of the second duration may be based on frame rate information associated with the media content. The frame rate information may correspond to a numeric data related to number of frames per second (FPS) of the media content, such as, “30 FPS”. In an embodiment, the determination of the second duration may be further based on location information of the received metadata in the media content. The location information may correspond to a data range related to number of frames within which one or more segments related to the metadata may be located. For example, a segment that corresponds to the metadata may be located between frame number, “30”, to the frame number, “360”. In an embodiment, the first duration and the second duration may be expressed as time offsets from start of the media content or may refer to particular frames in the media content.

In an embodiment, the conversion unit 204 may be operable to update first sub-metadata associated with the converted metadata, based on the determined second duration. The updated first sub-metadata may be utilized during synchronization of the close-caption information with the media content displayed at the electronic device 104.

In an embodiment, the processor 202 may be operable to determine location information of the converted closed-caption information in the media content. Such determination of the location information may be based on the frame rate information associated with the media content and duration of occurrence of the received metadata in the media content. In an embodiment, the frame rate information may be dynamically determined when the frame rate information is not available. In an embodiment, the conversion unit 204 may be operable to update first sub-metadata associated with the converted metadata, based on the determined location information.

In an embodiment, the conversion unit 204 may be operable to convert a first character encoding scheme associated with the retrieved metadata to a second character encoding scheme. Such conversion may be based on the first request. The first request may indicate use of the second character encoding scheme at the electronic device 104. Examples of such first and second character encoding schemes may include, but are not limited to, Extended Unix Code (EUC), Shift Japanese Industrial Standards (SJIS), Japanese Industrial Standards (WS), International Organization for Standardization (ISO)-2022-JP, ISO-8859-1, ISO-8859-2, American National Standards Institute (ANSI), ARABIC7, American Standard Code for Information Interchange (ASCII), Armenian Standard Code for Information Interchange (ARMSCII)-8, CSISO4UNITEDKINGDOM, CSISO17SPANISH, Universal Character Set 2-byte Little Endian (UCS-2LE), Unicode Transformation Format (UTF), Vietnamese Standard Code for Information Interchange (VISCID, and/or WINDOWS-1255.

In an embodiment, the conversion unit 204 may be operable to convert the retrieved metadata associated with the media content from a first language to a second language. In an exemplary scenario, metadata (in the first language, such as “English”) associated with a TV program (media content) may be displayed at the electronic device 104. The metadata (in the first language) was not created for a geographic region (for example, a linguistically different region, such as, “France”) in which the TV program is currently broadcasted. The first language of the metadata may be converted into the second language, such as “French”, associated with the TV program. Similarly, in another exemplary scenario, the display standards (or display) and/or video format of the broadcasted TV program may be different in different geographic regions in which the TV program is broadcasted. Further, the display and/or broadcasted TV program may have been built at a time when the standards for the closed-caption or subtitle information were not widely used. Thus, electronic devices in different geographic regions may not support a particular (or single) format of the metadata associated with the broadcasted TV program. In such scenarios, the conversion unit 204 may be operable to convert the original format of metadata such that the display and/or the broadcasted media content may support a converted format other than the format (original) used in the broadcast.

In an embodiment, the conversion unit 204 may be operable to cache the converted metadata at the conversion module 102. In an embodiment, the cached metadata may be stored in the memory 206 of the conversion module 102. In an embodiment, the cached metadata may be stored in another server, such as a file server.

In an embodiment, the conversion unit 204 may be operable to utilize the cached metadata when a second request for the metadata may be received from the electronic device 104. In an embodiment, the conversion unit 204 may be operable to utilize the same cached metadata when one or more subsequent requests may be received from multiple other electronic devices.

In an embodiment, the conversion unit 204 may be operable to compare the cached metadata with the metadata stored at the content server 106. Such comparison may be based on a date parameter, a time parameter, a file size parameter, and/or a checksum. In an embodiment, the conversion unit 204 may be operable to detect a modification in the metadata (such as closed caption content) stored at the content server 106 based on the comparison.

In an embodiment, the conversion unit 204 may be operable to communicate a second sub-metadata to the electronic device 104. The second sub-metadata may comprise the location identifier for the converted metadata. In an embodiment, the second sub-metadata may correspond to the structured file, such as, the “m3u8” file, where original URL of metadata may be substituted with the converted metadata. The communicated second sub-metadata may be utilized by the electronic device 104 to retrieve the converted metadata from the conversion module 102. In an embodiment, the location identifier may be a URL.

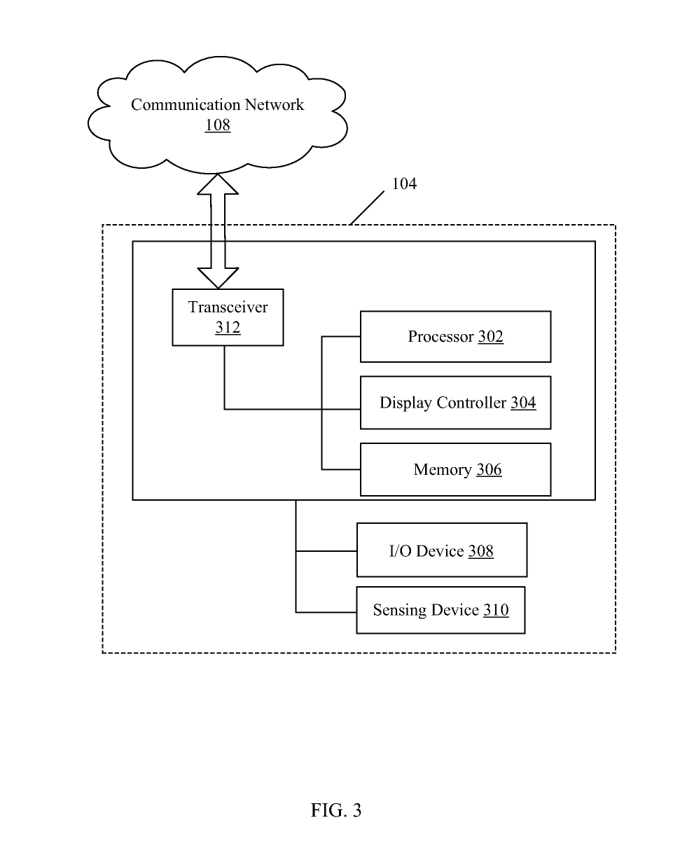

FIG. 3 is a block diagram that illustrates an exemplary electronic device, in accordance with an embodiment of the disclosure. FIG. 3 is explained in conjunction with elements from FIG. 1 and FIG. 2. With reference to FIG. 3, there is shown the electronic device 104. The electronic device 104 may comprise one or more processors, such as a processor 302, a display controller 304, a memory 306, one or more input/output (I/O) devices, such as an I/O device 308, one or more sensing devices, such as a sensing device 310, and a transceiver 312. The processor 302 may be communicatively coupled with the display controller 304, the memory 306, the I/O device 308, the sensing device 310, and the transceiver 312. The transceiver 312 may be operable to communicate with the one or more servers, such as the conversion module 102 and the content server 106, via the communication network 108.

The processor 302 may comprise suitable logic, circuitry, interfaces, and/or code that may be operable to execute a set of instructions stored in the memory 306. The processor 302 may be implemented based on a number of processor technologies known in the art. Examples of the processor 302 may be an X86-based processor, a Reduced Instruction Set Computing (RISC) processor, an Application-Specific Integrated Circuit (ASIC) processor, a Complex Instruction Set Computing (CISC) processor, and/or other processors.

The display controller 304 may comprise suitable logic, circuitry, interfaces, and/or code that may be operable to modify a layout of metadata displayed on the display screen 110 based on user preference. The modification may correspond to customization of appearance and location of the displayed metadata on the display screen 110. The appearance customizations may include, but are not limited to, a change in font type, font size, text color, background color, text height, text visibility, text shadow, character spacing of text, and/or and other look and feel of displayed metadata. The location customizations may include, but are not limited to, re-arranging layout related to horizontal position, horizontal alignment, vertical position, and/or vertical alignment.

The memory 306 may comprise suitable logic, circuitry, and/or interfaces that may be operable to store a machine code and/or a computer program with at least one code section executable by the processor 302. The memory 306 may further be operable to store information from one or more user profiles (such as user profile information of the user 112), and/or other data. The memory 306 may further be operable to store operating systems, and associated applications. In an embodiment, the memory 306 may further be operable to store layout settings for metadata. The layout settings may aid in customization of layout of the converted metadata displayed on the display screen 110. Examples of implementation of the memory 306 may include, but are not limited to, Random Access Memory (RAM), Read Only Memory (ROM), Hard Disk Drive (HDD), and/or a Secure Digital (SD) card.

The I/O device 308 may comprise suitable logic, circuitry, interfaces, and/or code that may be operable to receive an input from the user 112. The I/O device 308 may be further operable to provide an output to the user 112. The I/O device 308 may comprise various input and output devices that may be operable to communicate with the processor 302. Examples of the input devices may include, but are not limited to, a remote control of the electronic device 104, a touch screen, a keyboard, a mouse, a joystick, a microphone, a camera, a motion sensor, a light sensor, and/or a docking station. Examples of the output devices may include, but are not limited to, the display screen 110, and/or a speaker.

The sensing device 310 may comprise suitable logic, circuitry, and/or interfaces that may be operable to store a machine code and/or a computer program with at least one code section executable by the processor 302. The sensing device 310 may comprise one or more sensors to confirm recognition, identification, and/or verification of the user 112. The one or more sensors may comprise capacitive-touch sensors to detect one or more touch-based input actions received from the user 112. The sensing device 310 may further comprise an infrared (IR) receiver.

The transceiver 312 may comprise suitable logic, circuitry, interfaces, and/or code that may be operable to communicate with one or more servers, such as the conversion module 102 and the content server 106, via the communication network 108. The transceiver 312 may implement known technologies to support wired or wireless communication of the electronic device 104 with the communication network 108. The transceiver 312 may include, but is not limited to, an antenna, a radio frequency (RF) transceiver, one or more amplifiers, a tuner, one or more oscillators, a digital signal processor, a coder-decoder (CODEC) chipset, a subscriber identity module (SIM) card, and/or a local buffer. The transceiver 312 may communicate via wireless communication with networks, such as the Internet, an Intranet and/or a wireless network, such as a cellular telephone network, a wireless local area network (LAN) and/or a metropolitan area network (MAN).

In operation, the processor 302 in the electronic device 104 may be operable to display media content received from the content server 106. In an embodiment, the processor 302 may be further operable to communicate a first request to the conversion module 102, via the transceiver 312. In an embodiment, the first request may be indicative of an input provided by the user 112, to display the metadata.

In an embodiment, the processor 302 may be operable to receive a notification associated with the conversion of metadata from the conversion module 102. A message, such as “Your request is being processed, please wait for a moment” may be displayed on the display screen 110 for a pre-determined duration. This duration may correspond to the determined first duration at the conversion module 102. In an embodiment, the display of the media content may be halted for the determined duration. Such a halt may aid in synchronization of the converted metadata with the media content after which the display of the media content may resume. In an embodiment, the display of the media content may not be halted but the converted metadata may be displayed after the determined first duration.

In an embodiment, the transceiver 312 may be operable to receive the converted metadata from the conversion module 102. Such receipt may be in response to the first request communicated to the conversion module 102. The received metadata may comprise predetermined layout information stored in metadata of the converted metadata. The predetermined layout information may correspond to default appearance and location information of the metadata.

In an embodiment, the processor 302 may be operable to display the received metadata on the display screen 110, via the media player. In an embodiment, the media player may be a video player or a browser, such as a web browser. In an embodiment, the media player may be integrated with the web browser. In an embodiment, the web browser may render a user interface by use of a web-based application. In accordance with another embodiment, the media player may not be associated with the browser. In an embodiment, one or more functionalities of the conversion unit 204 may be performed by the media player. For example, the media player may be operable to convert the language and/or format of the retrieved metadata associated with the media content from a first language and/or format to a second language and/or format. The display of received metadata may be in a first layout based on predetermined layout information.

In an embodiment, the transceiver 312 may be operable to receive input for layout customization. In an embodiment, the input may be provided by the user 112. In an instance, a user, such as the user 112, may want to increase the font size of the displayed metadata. In another instance, the display of received metadata in the first layout may cover a portion of the display screen 110 that the user 112 may want to view. In such instances, the user 112 may want to modify the first layout as per his preference.

In an embodiment, the display controller 304 may be operable to modify the first layout of the displayed metadata in response to the received input. In an embodiment, the display controller 304 may be operable to display the converted metadata in a second layout based on the modification. The second layout may correspond to the customized appearance and/or customized location.

In an embodiment, the display controller 304 may be operable to communicate a modification request of the first layout to the conversion module 102. The conversion module 102 may be operable to update the metadata of the converted metadata in correspondence to received modification request. In an embodiment, the transceiver 312 may be operable to retrieve the updated metadata.

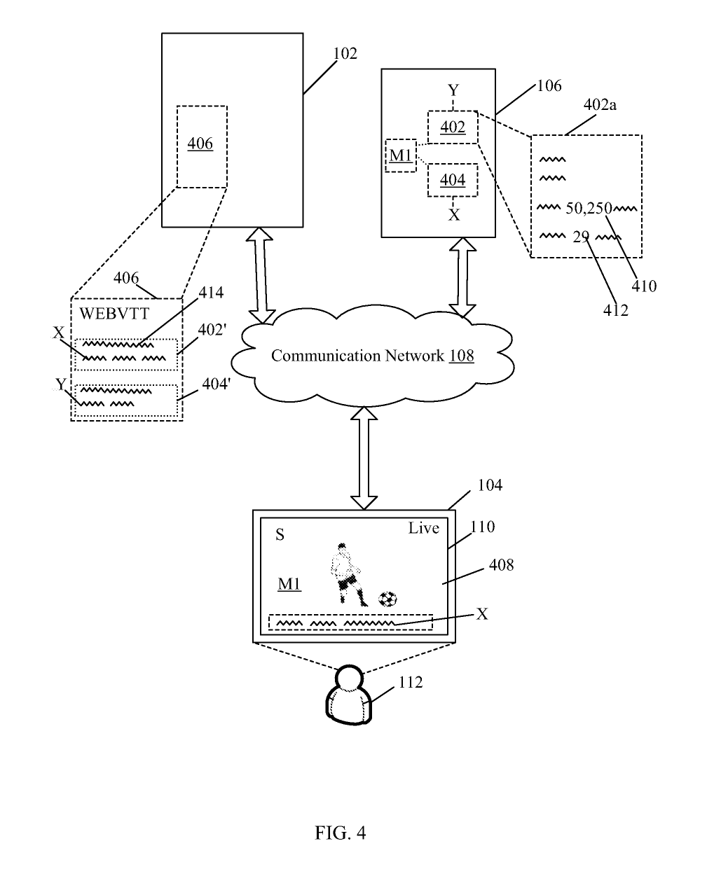

FIG. 4 illustrates an exemplary scenario for the disclosed implementation of the method and system that processes closed-caption information, in accordance with an embodiment of the disclosure. FIG. 4 is explained in conjunction with elements from FIG. 1, FIG. 2, and FIG. 3. With reference to FIG. 4, there is shown the conversion module 102, the electronic device 104, the content server 106, the communication network 108, the display screen 110, and the user 112. The electronic device 104 may be operable to display live IPTV content, “M1”, on the display screen 110, via a video player 408. The video player 408 may correspond to the media player rendered on the display screen 110. The content server 106 may be operable to store the closed-caption information in multiple segments, such as a first segment 402 and a second segment 404. The first segment 402 may include sub-metadata 402a. The sub-metadata 402a may comprise metadata elements, such as location information 410 and frame rate information 412, of the IPTV content, “M1”. The location information 410 may correspond to location of a closed caption, such as caption, “X”, associated with the first segment 402, in the IPTV content M1. A closed caption, such as caption, “Y”, may be associated with the second segment 404. The closed-caption information may be associated with the live IPTV content, “M1”. In an embodiment, the first segment 402 and the second segment 404 may correspond to the one or more segments of the closed-caption information in the first format, such as SMPTE-TT or DFXP. There is further shown converted closed-caption information 406 that may include sub-metadata 414, a converted first segment 402′ and a converted second segment 404′. In an embodiment, the converted closed-caption information 406 may correspond to the converted closed-caption information in the second format, such as WebVTT.

In the exemplary scenario, the electronic device 104 may be operable to display the live IPTV content, “M1”, such as a live soccer match at a channel, “S”, via the video player 408. In an embodiment, the video player 408 may be integrated with a web browser. The live IPTV content, “M1”, may be received from the content server 106, via the communication network 108. The first segment 402 and the second segment 404 may be in the first format not supported by the electronic device 104 for display. A user, such as the user 112, may be in a noisy environment or may be in a quiet environment where turning up the sound to a level where the user may understand the speech, such as of the live soccer match, would disturb other people.

The user 112 may want to view closed-captions associated with the displayed live soccer match. In an embodiment, the electronic device 104 (such as an IPTV) may be operable to receive input for the display of closed-caption information. The input may be provided by the user 112. In response to the received input, the electronic device 104 may be operable to communicate a first request to the conversion module 102.

In an embodiment, the processor 202 may be operable to receive the first request from the electronic device 104. The first request may comprise an authentication data. The first request may further comprise an identifier (such as a URL) for the closed-caption information associated with the live IPTV content, “M1”, and an identifier (such as another URL) for the IPTV content, “M1”.

In an embodiment, the conversion unit 204 of the conversion module 102 may be operable to determine whether the electronic device 104 is authorized to receive the closed-caption information from the conversion module 102. Such determination may be based on a comparison of the generated authentication data with a pre-stored authentication data at the conversion module 102.

In an embodiment, the conversion module 102 may be operable to communicate a discrete request to the content server 106 when the electronic device 104 may be determined to be authorized. In an embodiment, the conversion module 102 may be operable to retrieve the first segment 402 associated with the soccer match displayed at the electronic device 104.

In an embodiment, the conversion module 102 may be operable to convert the first segment 402 from the first format to a second format, such as WebVTT. The second format is supported by the electronic device 104. In an embodiment, the conversion module 102 may be operable to convert the retrieved first segment 402 from the first format to multiple other formats, such as SRT and/or SUB.

In an embodiment, the sub-metadata 402a associated with the first segment 402 may not have information related to duration associated with occurrence of the converted closed-caption information. The start time and end time of the caption, “X”, may not be provided. In such an embodiment, the conversion module 102 may be operable to determine the duration associated with occurrence of the converted closed-caption information. The converted closed-caption information may correspond to the converted first segment 402′, in the live IPTV content, “M1”. Such determination of the duration may be based on the frame rate information 412, such as “29 FPS”, of the live IPTV content, “M1”. Such determination of the duration of occurrence may be further based on the location information 410 of the first segment 402, of live IPTV content, “M1”. For example, the closed caption, “X”, in the first segment 402 may occur between frame number 50 and frame number 250 of the live IPTV content, “M1”.

In an embodiment, the conversion module 102 may be operable to update the sub-metadata 414 associated with the converted first segment 402′, based on the determined duration associated with occurrence of the converted closed-caption information. For example, the sub-metadata 414 may be updated to the start time of “two seconds” to end time of “nine seconds”. The updated sub-metadata 414 may be utilized during synchronization of the converted closed-caption information 406 with the live IPTV content, “M1”, such as the soccer match, displayed at the electronic device 104.

In an embodiment, the conversion module 102 may be further operable to convert a first character encoding scheme (such as ISO-2022-JP) associated with the retrieved first segment 402 to a second character encoding scheme (such as UTF-8). Such conversion to a second character encoding scheme may be based on the first request received from the electronic device 104. The first request may indicate use of the second character encoding scheme at the electronic device 104.

In an embodiment, the conversion module 102 may be operable to communicate the second sub-metadata to the electronic device 104. The communicated second sub-metadata may comprise a location identifier (such as a URL) for the converted closed-caption information 406 at the conversion module 102. The second sub-metadata may further comprise the identifier for the live IPTV content, “M1” at the content server 106. The communicated second sub-metadata may be utilized by the electronic device 104 to retrieve the converted closed-caption information 406 from the conversion module 102.

In an embodiment, the conversion module 102 may be operable to communicate another discrete request to the content server 106. The conversion module 102 may be operable to retrieve the second segment 404 associated with the live IPTV content displayed at the electronic device 104. Similarly, the conversion module 102 may be operable to convert the second segment 404 from the first format to the second format. The conversion module 102 may be operable to update the converted closed-caption information 406 based on the converted second segment 404′. Such an update of converted closed-caption information 406 may occur periodically as other segments of closed-caption information in the first format may be dynamically retrieved and converted. Thus, the electronic device 104 may be operable to continuously retrieve the converted closed-caption information 406 that may be periodically updated. Consequently, the user 112 may view the converted closed-caption information 406, such as the caption, “X”, followed by caption, “Y”, and subsequent captions continuously. The closed-caption information display consistency may be maintained even when the available closed-caption information in various formats may not have information related to the duration of occurrence of the closed-caption information in the one or more segments.

In an embodiment, the conversion module 102 may be further operable to cache the converted closed-caption information 406 at the conversion module 102. In an embodiment, the cached closed-caption information 406 may be utilized when a second request for the closed-caption information may be received from the electronic device 104 or another electronic device. For example, multiple users may view the soccer match in a repeat broadcast from a plurality of electronic devices. In such scenario, the cached closed-caption information 406 may be readily retrieved and displayed at the plurality of electronic devices.

In an embodiment, the closed caption information may also refer to text-based information associated with the media content, such as subtitles, text that provides program information and/or other metadata, such as title and time associated with the media content.

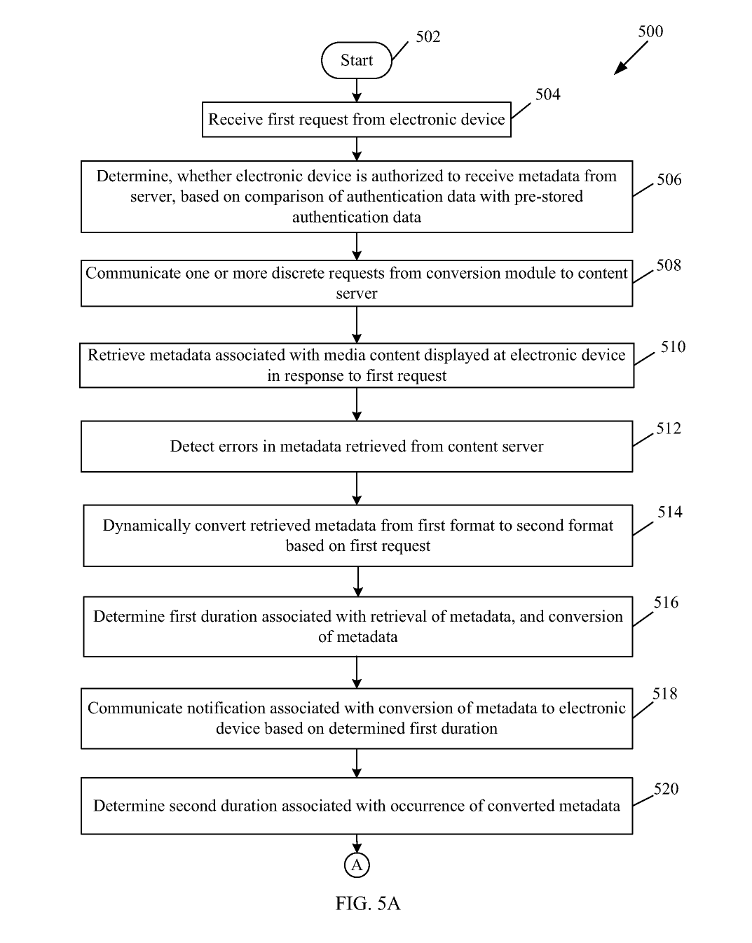

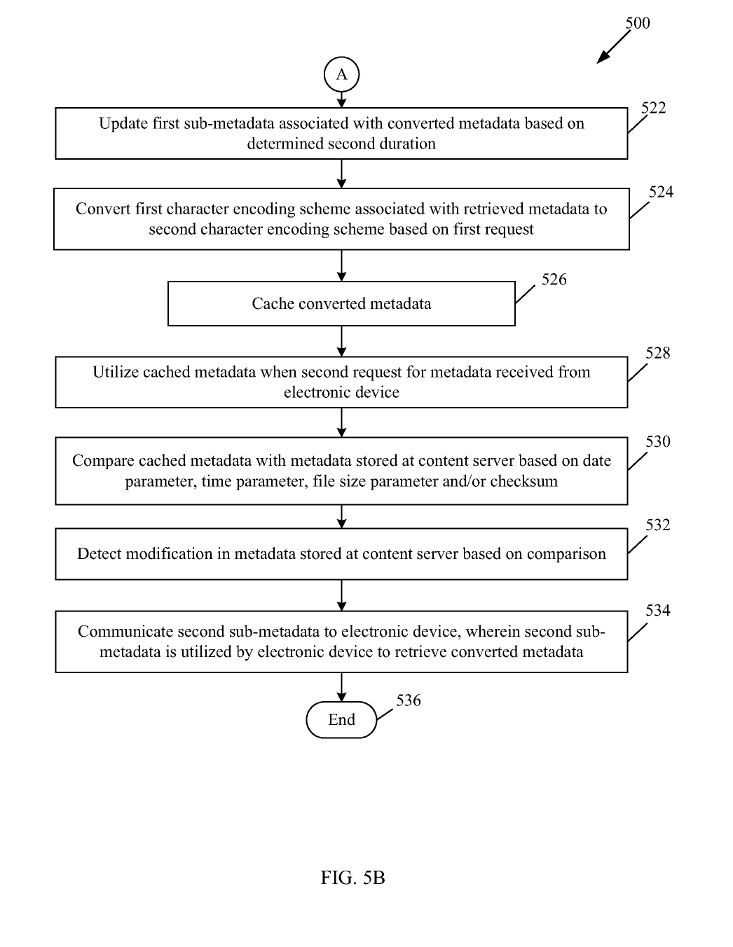

FIGS. 5A and 5B are a flow chart that illustrates an exemplary method to process closed-caption information, in accordance with an embodiment of the disclosure. With reference to FIGS. 5A and 5B, there is shown a flow chart 500. The flow chart 500 is described in conjunction with FIG. 1, FIG. 2, and FIG. 3. The method starts at step 502 and proceeds to step 504.

At step 504, a first request may be received from the electronic device 104. The first request may comprise an authentication data, an identifier for metadata associated with media content, and an identifier for media content. At step 506, whether the electronic device 104 is authorized to receive the metadata from the conversion module 102, may be determined. Such determination may be based on a comparison of the authentication data with a pre-stored authentication data.

At step 508, one or more discrete requests may be communicated to the content server 106. In an embodiment, the communication of the one or more discrete requests may be based on the determination related to the authorization of the electronic device 104. At step 510, the metadata associated with the media content displayed at the electronic device 104, may be retrieved. Such retrieval may occur in response to the first request received from the electronic device 104. In an embodiment, the retrieved metadata may be in a first format not supported by the electronic device 104. In an embodiment, the metadata may be retrieved in one or more segments based on the one or more discrete requests.

At step 512, errors may be detected in the metadata retrieved from the content server 106. Such detection may be based on a checksum parameter associated with the metadata. At step 514, the retrieved metadata may be converted from the first format to a second format supported by the electronic device 104. Such conversion may be based on the first request.

At step 516, a first duration associated with the retrieval of the metadata, and the conversion of the metadata, may be determined. At step 518, a notification associated with the conversion of the metadata may be communicated based on the determined first duration.

At step 520, a second duration associated with occurrence of the converted metadata in the media content, may be determined. Such determination of the second duration may be based on frame rate information associated with the media content. Such determination of the duration of occurrence may be further based on location information of received metadata in the media content. In an embodiment, the first duration and the second duration may be expressed as time offsets from start of the media content or may refer to particular frames in the media content. At step 522, a first sub-metadata associated with the converted metadata may be updated, based on the determined second duration. The updated second sub-metadata may be utilized during synchronization of the metadata with the media content displayed at the electronic device 104.

At step 524, a first character encoding scheme associated with the retrieved metadata may be converted to a second character encoding scheme. Such conversion may be based on the first request. At step 526, the converted metadata may be cached.

At step 528, the cached metadata may be utilized when a second request for the metadata may be received from the electronic device 104 or another electronic device. At step 530, the cached metadata may be compared with the metadata stored at the content server. Such comparison may be based on a date parameter, a time parameter, a file size parameter, and/or a checksum.

At step 532, a modification in the metadata stored at the content server 106 may be detected based on the comparison. At step 534, a second sub-metadata may be communicated to the electronic device 104. The communicated second sub-metadata may comprise a location identifier for the converted metadata. The communicated second sub-metadata may be utilized by the electronic device 104 to retrieve the converted metadata. Control passes to end step 536.

In accordance with an embodiment of the disclosure, a system that processes closed-caption information is disclosed. A conversion module, such as the conversion module 102 (FIG. 1), may comprise one or more processors (hereinafter referred to as the processor 202 (FIG. 2)). The processor 202 may be operable to retrieve metadata associated with media content displayed at the electronic device 104 (FIG. 1). Such retrieval may occur in response to a first request received from the electronic device 104. The retrieved metadata may be in a first format not supported by the electronic device. The processor 202 may be further operable to dynamically convert the retrieved metadata from the first format to a second format based on the first request. The second format may be supported by the electronic device 104.

Various embodiments of the disclosure may provide a non-transitory computer readable medium and/or storage medium, and/or a non-transitory machine readable medium and/or storage medium having stored thereon, a machine code and/or a computer program having at least one code section executable by a machine and/or a computer that processes closed-caption information. The at least one code section in the conversion module 102 may cause the machine and/or computer to perform the steps comprising retrieving closed-caption information associated with media content displayed at the electronic device 104 in response to a first request received from the electronic device 104. The retrieved metadata may be in a first format not supported by the electronic device 104. The retrieved metadata may be dynamically converted from the first format to a second format based on the first request. The second format may be supported by the electronic device 104.

The present disclosure may be realized in hardware, or a combination of hardware and software. The present disclosure may be realized in a centralized fashion, in at least one computer system, or in a distributed fashion, where different elements may be spread across several interconnected computer systems. A computer system or other apparatus adapted for carrying out the methods described herein may be suited. A combination of hardware and software may be a general-purpose computer system with a computer program that, when loaded and executed, may control the computer system such that it carries out the methods described herein. The present disclosure may be realized in hardware that comprises a portion of an integrated circuit that also performs other functions.

The present disclosure may also be embedded in a computer program product, which comprises all the features enabling the implementation of the methods described herein, and which when loaded in a computer system is able to carry out these methods. Computer program, in the present context, means any expression, in any language, code or notation, of a set of instructions intended to cause a system having an information processing capability to perform a particular function either directly, or after either or both of the following: a) conversion to another language, code or notation; b) reproduction in a different material form.

While the present disclosure has been described with reference to certain embodiments, it will be understood by those skilled in the art that various changes may be made and equivalents may be substituted without departing from the scope of the present disclosure. In addition, many modifications may be made to adapt a particular situation or material to the teachings of the present disclosure without departing from its scope. Therefore, it is intended that the present disclosure not be limited to the particular embodiment disclosed, but that the present disclosure will include all embodiments falling within the scope of the appended claims.

What is claimed is:

1. A method for processing closed-caption information, the method comprising:
in a conversion module:
retrieving metadata associated with media content being displayed at an electronic device in response to a first request received from said electronic device; and
dynamically converting said retrieved said metadata from said first format to a second format based on said received first request.

2. The method of claim 1, wherein said metadata is closed-caption information or subtitle information.

3. The method of claim 1, wherein said displayed said media content corresponds to pre-recorded Internet Protocol Television (IPTV) content and/or live IPTV content.

4. The method of claim 1, wherein said retrieved metadata is in a first format not supported by said electronic device, and wherein said second format is supported by said electronic device.

5. The method of claim 1, further comprising receiving said first request from said electronic device, wherein said first request comprises an authentication data, a first identifier for said metadata associated with said media content, and a second identifier for said media content.

6. The method of claim 5, further comprising determining, whether said electronic device is authorized to receive said metadata from said conversion module, based on a comparison of said authentication data with a pre-stored authentication data.

7. The method of claim 1, wherein said metadata is retrieved in one or more segments based on one or more discrete requests communicated from said conversion module to a content server.

8. The method of claim 1, further comprising detecting errors in said metadata retrieved from a content server based on a checksum parameter associated with said metadata.

9. The method of claim 1, further comprising determining a first duration associated with said retrieval and said conversion.

10. The method of claim 9, further comprising communicating a notification associated with said conversion of said metadata to said electronic device based on said determined first duration.

11. The method of claim 1, further comprising determining a second duration associated with occurrence of said converted metadata in said media content based on frame rate information associated with said media content, and/or location information of said retrieved metadata in said media content.

12. The method of claim 11, further comprising updating a first sub-metadata associated with said converted metadata based on said determined second duration, wherein said updated first sub-metadata is utilized when said converted metadata is synchronized with said media content displayed at said electronic device.

13. The method of claim 1, further comprising converting a first character encoding scheme associated with said retrieved metadata to a second character encoding scheme based on said first request, wherein said second character encoding scheme is supported by said electronic device.

14. The method of claim 1, further comprising caching said converted metadata.

15. The method of claim 14, further comprising utilizing said cached metadata when a second request for said metadata is received from said electronic device.

16. The method of claim 14, further comprising utilizing said cached metadata when another request for said metadata is received from another electronic device.

17. The method of claim 14, further comprising:
comparing said cached metadata to said metadata stored at a content server based on a date parameter, a time parameter, a file size parameter, and/or a checksum; and
detecting a modification in said metadata stored at said content server based on said comparison.

18. The method of claim 14, further comprising communicating a second sub-metadata to said electronic device, wherein said second sub-metadata comprises a location identifier for said converted metadata, and wherein said second sub-metadata is utilized by said electronic device to retrieve said converted metadata.

19. The method of claim 18, wherein said location identifier is a uniform resource locator (URL).

20. A system for processing of closed-caption information, the system comprising:
one or more processors in a conversion module, said one or more processors being operable to:
retrieve metadata associated with media content being displayed at an electronic device in response to a first request received from said electronic device; and
dynamically convert said retrieved metadata from said first format to a second format based on said received first request.

21. The system of claim 20, wherein said metadata is closed-caption information or subtitle information.

22. The system of claim 20, wherein said displayed said media content corresponds to prerecorded Internet Protocol Television (IPTV) content and/or live IPTV content.

23. A non-transitory computer-readable storage medium having stored thereon, a computer program having at least one code section for processing of closed-caption information, the at least one code section being executable by a computer for causing the computer to perform steps comprising:
retrieving metadata associated with media content being displayed at an electronic device in response to a first request received from said electronic device; and
dynamically converting said retrieved said metadata from said first format to a second format based on said first request.
